(19) United States
(12) Patent Application Publication
(10) Pub. No.: US 2014/0108077 A1
(43) Pub. Date: Apr. 17, 2014

(54) DYNAMIC TASK ASSIGNMENT

(71) Applicant: DISNEY ENTERPRISES, INC., Burbank, CA (US)

(72) Inventors: Amber Samdahl, La Canada Flintridge, CA (US); Jeffrey Voris, Pasadena, CA (US)

(21) Appl. No.: 13/651,011

(22) Filed: Oct. 12, 2012

(51) Int. Cl. G06Q 10/06

(52) U.S. Cl. CPC G06Q 10/063112
USPC 705/7.14

(57) ABSTRACT

A task profile for a task is generated. The task profile includes at least one intrinsic property of the task and at least one transient property of the task. Further, participant profile of the task is generated for each participant in a predefined set of participants that qualify for performance of the task. In addition, a score is calculated for each participant profile by matching the participant profile to the task profile. A participant is selected from the predefined set of participants according to the score for each participant. Further, the task is assigned to the participant.

### BACKGROUND

1. Field

This disclosure generally relates to the field of workflow management. More particularly, the disclosure relates to task assignment.

2. General Background

A workflow is a sequence of events in which tasks are to be performed. A workflow management system is a system that defines the workflow for a given project and assigns tasks to various workers and resources according to the workflow.

Most communication systems that support workflow management assume that a given task will be assigned to a particular participant. When a variety of participants may perform the task, these communication systems typically utilize either a manual approach or an automatic approach to select a participant to assign the task. The manual approach involves a human being performing the selection based upon personal knowledge. Such an approach is labor intensive and subject to human error.

Alternatively, the automatic approach considers all of the participants to be fungible. The automatic approach may utilize a variety of algorithms, e.g., a fairness algorithm, a load balancing algorithm, a reward for past performance algorithm, or the like, to select the participant to perform the task. This approach may not select the most ideal participant for the particular task given the timing and dynamic context in which the task is assigned. It is believed that improvements in communications systems that support workflow management are needed to provide for better task assignment.

### SUMMARY

In one aspect of the disclosure, a computer program product is described. The computer program product includes a computer readable medium having a computer readable program stored thereon. The computer readable program while executing on a computer causes the computer to generate a task profile for a task. The task profile includes at least one intrinsic property of the task and at least one transient property of the task. Further, the computer readable program while executing on the computer causes the computer to generate a participant profile of the task for each participant in a predefined set of participants that qualify for performance of the task. In addition, the computer readable program while executing on the computer causes the computer to calculate a score for each participant profile by matching the participant profile to the task profile. The computer readable program while executing on the computer also causes the computer to select a participant from the predefined set of participants according to the score for each participant. Further, the computer readable program while executing on the computer causes the computer to assign the task to the participant.

In another aspect of the disclosure, a process is described. The process generates a task profile for a task. The task profile includes at least one intrinsic property of the task and at least one transient property of the task. Further, the process generates a participant profile of the task for each participant in a predefined set of participants that qualify for performance of the task. In addition, the process calculates, with a processor, a score for each participant profile by matching the participant profile to the task profile. The process also selects a participant from the predefined set of participants according to the score for each participant. Further, the process assigns the task to the participant.

In yet another aspect of the disclosure, a system is described. The system comprises a processor configured to generate a task profile for a task, generate a participant profile of the task for each participant in a predefined set of participants that qualify for performance of the task, calculate a score for each participant profile by matching the participant profile to the task profile, select a participant from the predefined set of participants according to the score for each participant, assign the task to the participant. The task profile includes at least one intrinsic property of the task and at least one transient property of the task.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a dynamic task configuration that is utilized to dynamically assign a task.

FIG. 2 illustrates the profiles generated by the dynamic task assignment system.

FIG. 3 illustrates the components of the dynamic task assignment system illustrated in FIGS. 1 and 2.

FIG. 4 illustrates a process that is utilized to provide dynamic task assignment.

### DETAILED DESCRIPTION

A computer program product, method, and system are utilized to provide dynamic task assignment, which allows a participant to be selected from a predefined set of participants to perform a task in a workflow. The dynamic workflow may be utilized in any workflow where tasks are assigned to a predefined set of participants. Examples of such workflows include, but are not limited to, delivery services, taxi dispatch systems, installation services, repair services, online help desks, call center routing, selection of entertainment personnel in an entertainment environment, selection of entertainment/game participants, or the like.

A given task is characterized by generating a task profile. Further, participant profiles are generated for each participant in the predefined set of participants. At task assignment time, the task profile is matched to the participant profile of the participant in the predefined set of participants that most ideally performs the task. As a result, an automated approach may be utilized that is less labor intensive than the manual approach and more accurate than current automated approaches.

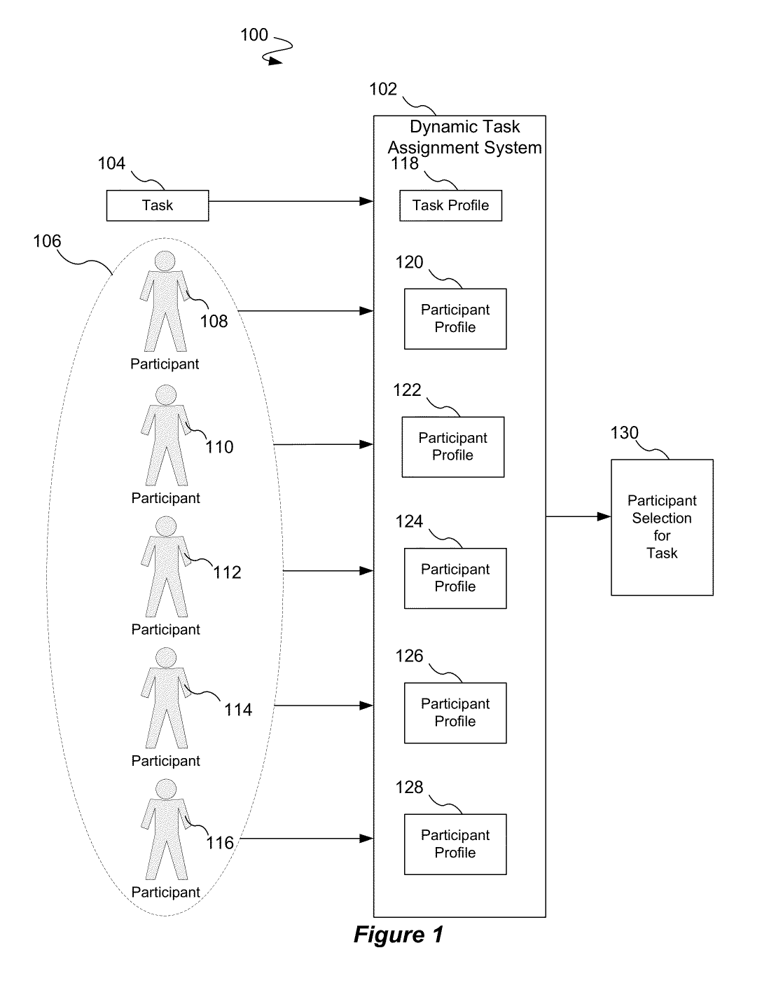

FIG. 1 illustrates a dynamic task configuration 100 that is utilized to dynamically assign a task. A dynamic task assignment system 102 receives a task 104 and a predefined set of participants that qualify to perform the task. As an example, the predefined set of participants 106 may include a participant 108, a participant 110, a participant 112, a participant 114, and a participant 116. The participants may each be a person, company, organization, or the like. The dynamic task assignment system 102 receives information regarding each participant in the predefined set of participants 106.

The dynamic task assignment system 102 generates a task profile 118 based upon the task 104 that is received. The task profile 118 includes at least one intrinsic property of the task and at least one transient property of the task. In one aspect, the intrinsic properties are particular skills necessary to perform the task. For example, a delivery service task may have intrinsic properties such as the abilities to drive and lift heavy objects. In one aspect, the transient properties are properties that are changing on a frequent basis. For example, a transient property may be physical proximity. For instance, a transient property of a task is a delivery service having to be local for pickup of a product for delivery.

Further, the dynamic task assignment system 102 generates a participant profile for each participant. In FIG. 1, the dynamic task assignment system 102 generates a participant profile 120 for the participant 108, a participant profile 122 for the participant 110, a participant profile 124 for the participant 112, a participant profile 126 for the participant 114, and a participant profile 128 for the participant 116. Each participant profile indicates preferences, rules, and/or characteristics for a participant. The preferences indicate a type of task, work environment, or the like preferred by the participant. Further, the rules indicate particular conditions for the participant to work on the task. In addition, the characteristics indicate particular skills of the participant.

At task assignment time, the dynamic task assignment system 102 matches the task profile 104 to the participant profile that most ideally meets the task profile 104. In one aspect, a scoring methodology is utilized to score each participant profile. The dynamic task assignment system 102 ranks each participant profile according to the respective score and then assigns the task to the participant with the highest score.

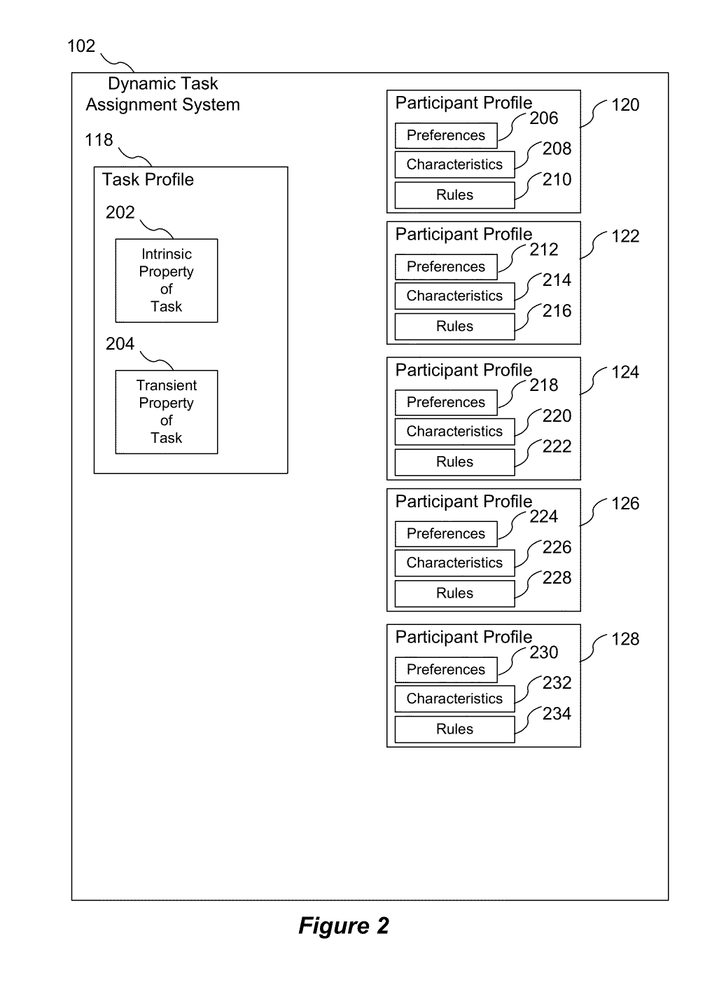

FIG. 2 illustrates the profiles generated by the dynamic task assignment system 102. The dynamic task assignment system 102 generates a task profile 118 that has an intrinsic property 202 and a transient property 204. Further, the dynamic task assignment system 102 generates a participant profile for each of the participants. Accordingly, the dynamic task assignment system 102 generates a participant profile 120 having preferences 206, characteristics 208, and rules 210, a participant profile 122 having preferences 212, characteristics 214, and rules 216, a participant profile 124 having preferences 218, characteristics 220, and rules 222, a participant profile 126 having preferences 224, characteristics 226, and rules 228, and a participant profile 120 having preferences 206, characteristics 208, and rules 210. The dynamic task assignment system 102 compares each participant profile with the task profile 118 to generate a score for each participant. As the task profile 118 includes the transient property 204, the dynamic task assignment system 102 determines the current task requirements that may have recently changed. Accordingly, the dynamic task assignment system 102 determines both the static task requirements, i.e., through the intrinsic property 202, and the dynamic task requirements, i.e., through the transient property 204. Although a single intrinsic property 202 and a single transient property 204 are illustrated for ease of illustration, the task profile 118 may have multiple intrinsic properties 202 and/or multiple transient properties 204.

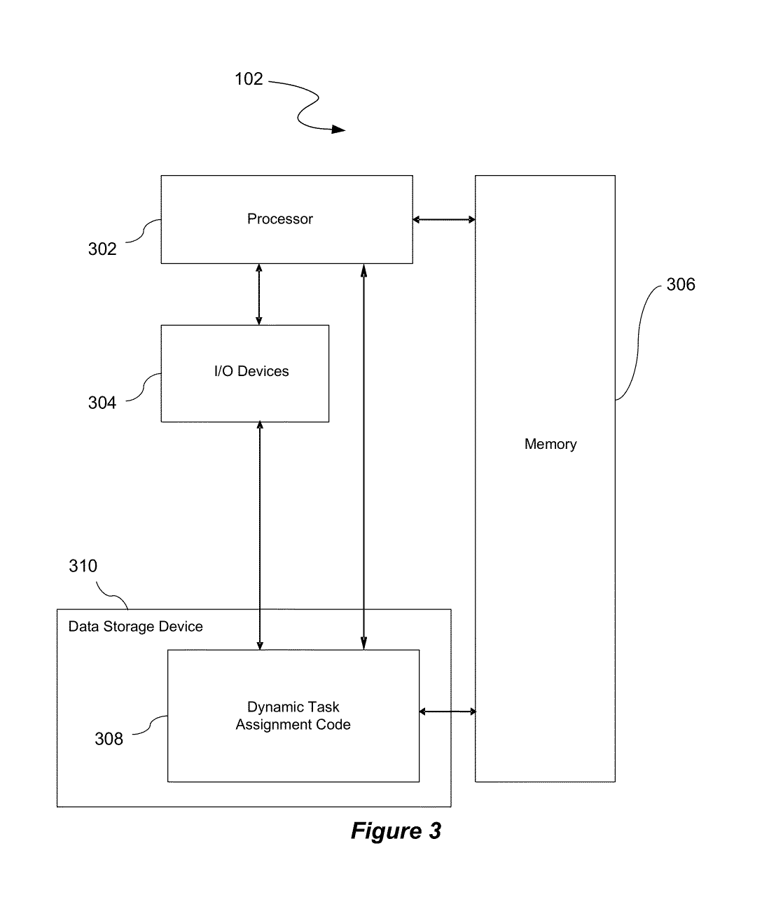

FIG. 3 illustrates the components of the dynamic task assignment system 102 illustrated in FIGS. 1 and 2. In one aspect, the dynamic task assignment system 102 is implemented utilizing a general purpose computer or any other hardware equivalents. As illustrated, the dynamic task assignment system 102 comprises a processor 302, a memory 306, e.g., random access memory (“RAM”) and/or read only memory (ROM), a set of dynamic task assignment code 308 that provides instructions for profile generation, score calculation, participant selection, and task assignment, a data storage device 310 that stores the set of dynamic task assignment code 308, and various input/output devices 304, (e.g., audio/video outputs and audio/video inputs, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)). In one aspect, the dynamic task assignment code 308 may be implemented as a software application such as a mobile application, a desktop application, a web application, or the like.

In one aspect, the set of dynamic task assignment code 308 is loaded from a storage medium associated with the data storage device 310, e.g., a magnetic or optical drive, diskette, or non-volatile memory, and operated by the processor 302 in the memory 306 of the system 304. As such, the set of dynamic task assignment code 308 (including associated data structures) of the present disclosure may be stored on a computer readable medium, e.g., RAM memory, magnetic or optical drive or diskette or the like.

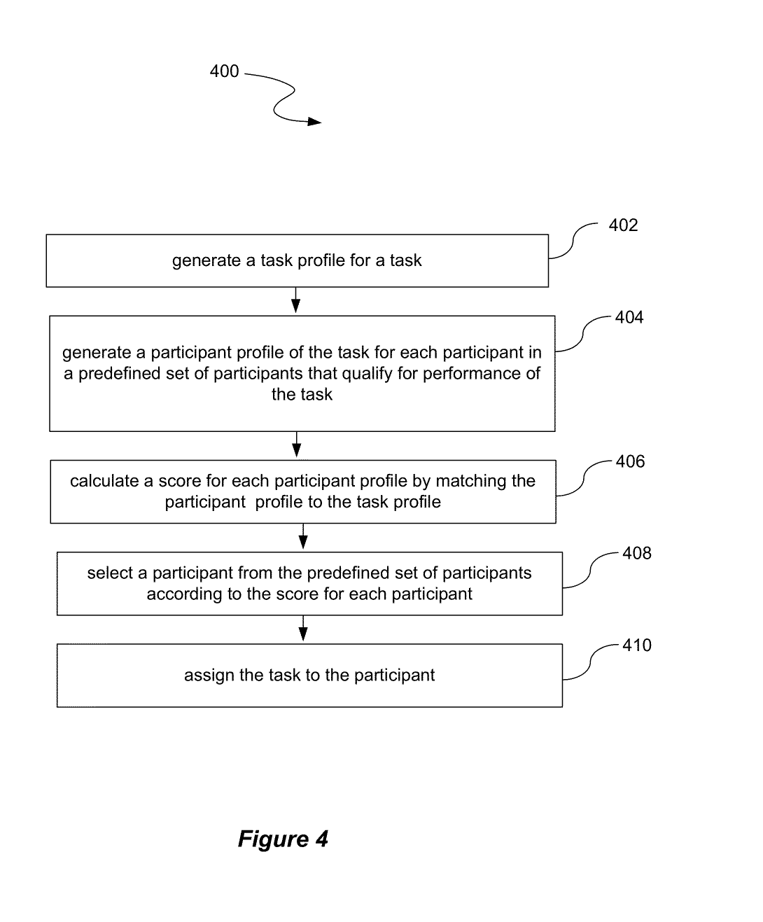

FIG. 4 illustrates a process 400 that is utilized to provide dynamic task assignment. At a process block 402, the process 400 generates a task profile for a task. The task profile includes at least one intrinsic property of the task and at least one transient property of the task. Further, at a process block 404, the process 400 generates a participant profile of the task for each participant in a predefined set of participants that qualify for performance of the task. In addition, at a process block 406, the process 400 calculates a score for each participant profile by matching the participant profile to the task profile. At a process block 408, the process 400 selects a participant from the predefined set of participants according to the score for each participant. Further, at a process block 410, the process 400 assigns the task to the participant.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or a computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above. For example, a computer may be a personal computer (“PC”), laptop, smartphone, tablet device, set top box, or the like.

It is understood that the apparatuses, systems, computer program products, and processes described herein may also be applied in other types of apparatuses, systems, computer program products, and processes. Those skilled in the art will appreciate that the various adaptations and modifications of the aspects of the apparatuses, systems, computer program products, and processes described herein may be configured without departing from the scope and spirit of the present apparatuses, systems, computer program products, and processes. Therefore, it is to be understood that, within the scope of the appended claims, the present apparatuses, systems, computer program products, and processes may be practiced other than as specifically described herein.

We claim:

1. A computer program product comprising a computer readable storage device having a computer readable program stored thereon, wherein the computer readable program while executing on a computer causes the computer to:
generate a task profile for a task, the task profile including at least one intrinsic property of the task and at least one transient property of the task;
generate a participant profile of the task for each participant in a predefined set of participants that qualify for performance of the task;
calculate a score for each participant profile by matching the participant profile to the task profile;
select a participant from the predefined set of participants according to the score for each participant; and
assign the task to the participant.

2. The computer program product of claim 1, wherein the at least one intrinsic property is a skill associated with performance of the task.

3. The computer program product of claim 1, wherein the at least one intrinsic property is a cost associated with performance of the task.

4. The computer program product of claim 1, wherein the at least one transient property is measured at a time of task assignment.

5. The computer program product of claim 1, wherein the at least one transient property is proximity to the task profile.

6. The computer program product of claim 1, wherein the at least one transient property is workload.

7. The computer program product of claim 1, wherein the participant profile includes a plurality of preferences, a plurality of rules, and a plurality of characteristics.

8. A method comprising:
generating a task profile for a task, the task profile including at least one intrinsic property of the task and at least one transient property of the task;
generating a participant profile of the task for each participant in a predefined set of participants that qualify for performance of the task;
calculating, with a processor, a score for each participant profile by matching the participant profile to the task profile;
selecting a participant from the predefined set of participants according to the score for each participant; and
assigning the task to the participant.

9. The method of claim 8, wherein the at least one intrinsic property is a skill associated with performance of the task.

10. The method of claim 8, wherein the at least one intrinsic property is a cost associated with performance of the task.

11. The method of claim 8, wherein the at least one transient property is measured at a time of task assignment.

12. The method of claim 8, wherein the at least one transient property is proximity to the task profile.

13. The method of claim 8, wherein the at least one transient property is workload.

14. The method of claim 8, wherein the participant profile includes a plurality of preferences, a plurality of rules, and a plurality of characteristics.

15. A system comprising:
a processor configured to generate a task profile for a task, generate a participant profile of the task for each participant in a predefined set of participants that qualify for performance of the task, calculate a score for each participant profile by matching the participant profile to the task profile, select a participant from the predefined set of participants according to the score for each participant, assign the task to the participant, the task profile including at least one intrinsic property of the task and at least one transient property of the task.

16. The system of claim 15, wherein the at least one intrinsic property is a skill associated with performance of the task.

17. The system of claim 15, wherein the at least one intrinsic property is a cost associated with performance of the task.

18. The system of claim 15, wherein the at least one transient property is measured at a time of task assignment.

19. The system of claim 15, wherein the at least one transient property is proximity to the task profile.

20. The system of claim 15, wherein the at least one transient property is workload.

21. The system of claim 15, wherein the participant profile includes a plurality of preferences, a plurality of rules, and a plurality of characteristics.
